(19) United States
(12) Patent Application Publication
(10) Pub. No.: US 2017/0127620 A1
(43) Pub. Date: May 11, 2017

(54) GARDEN STAKES

(71) Applicant: Rebecca GALATE, Carrollton, GA (US)

(72) Inventor: Rebecca GALATE, Carrollton, GA (US)

(21) Appl. No.: 15/098,857

(22) Filed: Apr. 14, 2016

Related U.S. Application Data
(60) Provisional application No. 62/252,663, filed on Nov. 9, 2015.

(51) Int. Cl. A01G 9/12; A01G 1/00

(52) U.S. Cl. CPC A01G 9/122; A01G 1/001; A01G 9/128

(57) ABSTRACT

Disclosed is a firm support for long stem flowers or plants. The stake is provided with interlocking clips with open and close cylinders that hold the plant stem in place. A node is provided on the periphery of the cylinder, which facilitates small hinge operation with a strong magnetic closure for open/close of a cylinder that holds the stem in place.

### CROSS-REFERENCE TO RELATED APPLICATIONS

The present application claims priority from U.S. Provisional Patent Application Ser. No. 62/252663, filed on Nov. 9, 2015 and entitled “Happy Stakes”.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

1. Field of the Invention

The present invention generally relates to the field of garden stakes for supporting plants. The invention, particularly relates to a garden stake for supporting plant stem that utilizes interlocking clips having an open cylinder on the end that holds a plant stem.

2. Description of Related Art Including Information Disclosed Under 37 CFR 1.97 and 37 CFR 1.98.

Garden stakes are commonly used to support growing plants. Most are simple, straight support members, such as bamboo stakes. While there are many ways to stake up a plant or vine, they require a lot of time and effort to sake and cut ribbon and tie around a plant. String can be used to support a plant next to the stake. Stakes have improved upon this simple example to include support wires to surround a plant. Multiple upright support members joined with hoops have also been employed and may be especially useful for fruit or vegetable bearing plants, such as tomatoes.

Moreover a gardener has to regularly carry different tools and has to bend to tend to the stake that might have got bent due to heavy wind or like. Also, the stakes used do not have multiple points to hold the plant in place. Furthermore, as a plant grows the support needs may change and a single stake size may not accommodate all plant sizes and support concerns.

A number of different types of garden stakes for supporting plants are present in prior art. For example U.S. Pat. No. 8,006,434 to Allsop et al. discloses a stake for insertion in soil to support an item such as a plant. The stake includes a primary shaft and a foot adjustably secured to the primary shaft. The primary shaft has an upper end and a lower end. The lower end is configured for insertion into the soil at a first location. The foot has a supporting protrusion for insertion into the soil at a second location removed from the first location. The foot is adjustable for translation along at least a portion of the primary shaft.

Another U.S. Pat. No. 8,215,057 to Paul discloses an apparatus for supporting the calyx of a flower of a plant having a lockable stem clip from which extend projections for supporting the calyx of the flower. Stem clip is generally cylindrical and may be made of any type of plastic, rubber or similar material in which the clip may be opened, placed around the stem of a flowering plant, and then closed again to at partially enclose around the stem. Stem clip provides support for the proximal stem of the flower, that is, the portion of the stem adjacent to the flower head. This support prevents premature degradation of the nutrient transport system of the stem, and prolongs the useful life of the flower.

Another prior art U.S. patent application Ser. No. 13/681,070 to Warren et al discloses a plant support system including a frame for surrounding the one or more plants and a fastener for coupling the frame to a stake. The frame includes a first frame member having two wires slidably positioned relative to one another to adjust the frame size, wherein each wire comprises a first end and wherein the first ends of the two wires are interconnected relative to one another such that the first ends slidably overlap one another.

None of the mentioned prior arts provide a solution to the problems mentioned above. Hence, there is a need to develop an improved plant support system capable of efficiently adjusting the size and vertical position of a plant supporting frame. There is also a need to develop a durable, load bearing plant support system capable of supporting plants of varying sizes and compatible with a wide range of stakes.

### BRIEF SUMMARY OF THE INVENTION

In the view of the foregoing disadvantages inherent in the known types of garden stakes for supporting plants now present in the prior art, the present invention provides a garden stake for supporting plant stem by utilizing interlocking clips. As such, the general purpose of the present invention, which will be described subsequently in greater detail, is to provide a new and improved garden stake for supporting plant stem which has all the advantages of the prior art and none of the disadvantages.

An object of the invention is to provide a firm support for long stem flowers or plants.

It is another object of the present invention to provide the interlocking clips to a stake with push and close cylinders that hold the plant stem in place.

It is another object of the present invention to provide the interlocking clips which can stay on the ground.

It is another object of the present invention to the interlocking clips that are adjustable and can be moved while plant grows.

It is another object of the present invention to provide a small hinge operation with strong magnetic closure for open/close of a cylinder that holds the stem in place.

It is another object of the present invention to provide a stake that accommodates multiple plants at one time.

It is another object of the present invention to provide a stake that allows multiple points to hold the plant in place.

It is another object of the present invention to provide interlocking clips that are durable.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE SEVERAL VIEWS OF THE DRAWINGS

The invention will be better understood and objects other than those set forth above will become apparent when consideration is given to the following detailed description thereof Such description makes reference to the annexed drawings wherein:

FIG. 1 shows a perspective view of a multi-arm interlock for the stake.

FIG. 2 shows the perspective view of a stake for supporting plant stem.

### DETAILED DESCRIPTION OF THE INVENTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that logical and structural changes may be made without departing from the spirit and scope of the present invention. The following detailed description is, therefore, not to be taken in a limiting sense, and the scope of the present invention is defined by the appended claims and their equivalents.

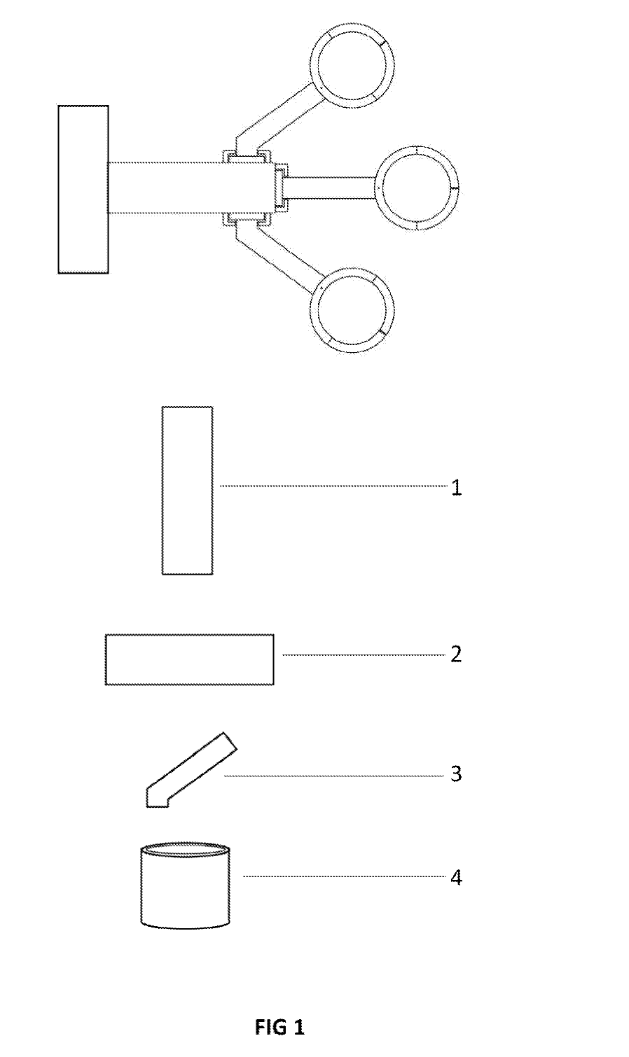

On referring FIG. 1 illustrates a multi-arm interlock for stake 9. The figure shows an interlock or slide clip 1, extension arms 2, extender's 3 and cylinders or guards 4. The extension arms are for example 2 to 4 inches long, extenders are approximately 3 inches long and cylinders or guards are for example 2 to 4 inches long. The interlock clips are made up of preferably acrylic material for durability.

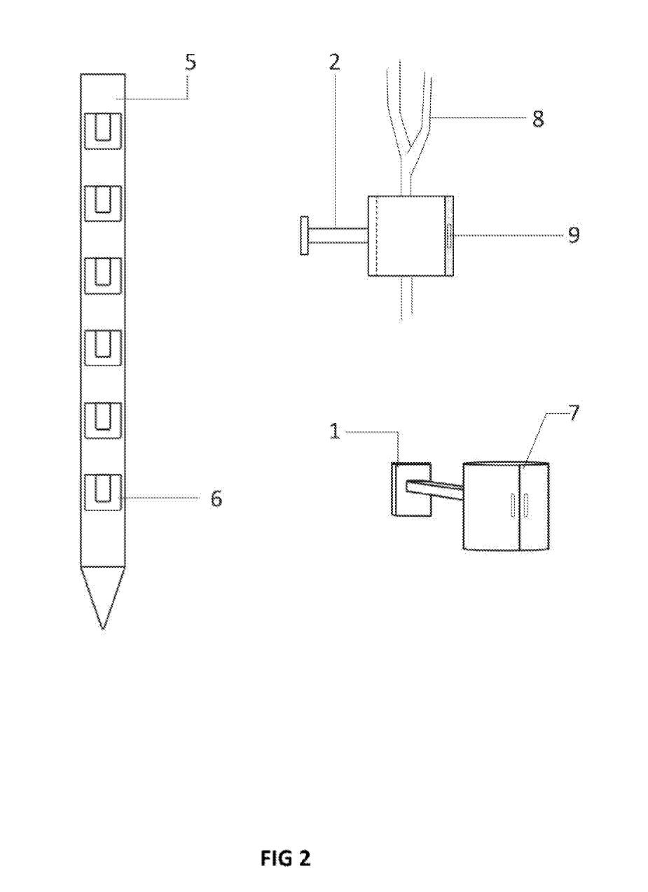

FIG. 2 illustrates a stake 5 for supporting plant stem. The stake 5 has four sides and is not necessarily square in shape. The stake 5 has ‘U’ shaped locks 8 at its periphery. These U shaped locks enable the stake to connect to interlocking clip 1. The figure also shows different representations of the connections between the different parts of the supporting structure for the plant stem. For example, the figure shows connection between extension arm 2 and cylinder 4 on one side with the hinge. In other representation, the figure shows an interlock 1 slide into a U lock 8 and an extension arm 2 that connects interlock with the cylinder 4 and an interlock slides into a ‘U’ lock 6.

Similarly, another representation shows the magnetic closure 7, a plant stem 8 surrounded by a cylinder and interlock clip. The representation also shows a node 9 on the periphery of the cylinder. The node 9 is provided to push back and open the cylinder to allow the plant stem 8 to be supported; to enter and pass along the length of the cylinder and through it.

Conventional methods can damage a plant or vine by over tying the plant, as well as allowing the plant to fall out of the stake or break due to wing or animals. Again, conventional stakes are one per plant and with the present invention, it is possible to stake multiple plants at one time, thus cutting time, effort and cost in half or more.

The present invention eliminates the need to carry tools, excessive bending and operation with just a finger or two. The structure allows for multiple points to hold the plant in place as well as allowing the plant to breathe, thus reducing mold powdery mildew and often times rot and hiding places for plant mites.

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention.

I claim:

1. A firm-support structure for a plant stem, comprising:
a stake;
at least one cylinder;
at least one extension arm;
at least one interlocking clip.

2. The firm-support structure for a plant stem according to claim 1, wherein said stake has four sides.

3. The firm-support structure for a plant stem or like according to claim 1, wherein said stake goes into the ground.

4. The firm-support structure for a plant stem or like according to claim 1, wherein said stake has a plurality of ‘U’ shaped locks at a periphery of said stake.

5. The firm-support structure for a plant stem or like according to claim 1, wherein at least one cylinder has a node installed at a periphery of said cylinder.

6. The firm-support structure for a plant stem or like according to claim 5, wherein said node is pushed back to enable at least one cylinder to hold said plant stem.

7. The firm-support structure for a plant stem or like according to claim 1, wherein at least one extension arm connects at least one cylinder with at least one interlocking clip.

8. The firm-support structure for a plant stem or like according to claim 1, wherein at least one interlocking clip is slide into ‘U’ shaped locks at said periphery of said stake.

9. A method for supporting a plant stem, comprising steps of:
providing a stake with a plurality of ‘U’ shaped locks;
providing at least one cylinder with a node;
providing at least one extension arm;
providing at least one interlocking clip.

10. The method for supporting a plant stem according to claim 9, wherein said plurality of ‘U’ shaped locks are positioned at periphery of said stake.

11. The method for supporting a plant stem according to claim 9, wherein said stake with said plurality of ‘U’ shaped locks, goes into the ground.

12. The method for supporting a plant stem according to claim 9, wherein said node is positioned at periphery of at least one cylinder.

13. The method for supporting a plant stem according to claim 12, wherein said node is pushed back to allow said plant stem to be held by at least one cylinder.

14. The method for supporting a plant stem according to claim 13, wherein said pushing back of node is enabled by a small hinge operation with a strong magnetic closure.

15. The method for supporting a plant stem according to claim 9, wherein said at least one extension arm connects at least one cylinder with at least one interlocking clip.

16. The method for supporting a plant stem according to claim 9, wherein at least one interlocking clip is slide into ‘U’ shaped locks at the periphery of said stake.

17. The method for supporting a plant stem according to claim 16, wherein at least one interlocking clip is adjusted according to the growth of plant.

18. The method for supporting a plant stem according to claim 9, wherein at least one interlocking clip is made up of acrylic material.
